(19) United States
(12) Patent Application Publication
(10) Pub. No.: US 2010/0052274 A1
(43) Pub. Date: Mar. 4, 2010

(54) CART ASSEMBLIES FOR USE WITH BLOOD FILTRATION

(76) Inventors: Richard L. West, Lake Villa, IL (US); Anthony Oleszkiewicz, Round Lake, IL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/548,235

(22) Filed: Aug. 26, 2009

Related U.S. Application Data
(60) Provisional application No. 61/092,113, filed on Aug. 27, 2008.

(51) Int. Cl. B62B 1/00

(52) U.S. Cl. 280/47.24

(57) ABSTRACT

Cart assemblies for use with blood filtration are described. An example cart assembly for use with blood filtration includes a base including a recessed portion to receive one or more containers defining compartments each to receive a container of a fluid transfer system. Additionally, the base includes a plurality of transport members coupled to respective portions of the base. A plane on which a surface of the recessed portion lies is below a portion of each of the plurality of transport members. Additionally, the cart assembly includes a hanger assembly comprising a plurality of suspension members from which another container of the fluid transfer system is to be suspended and a pole to couple the base to the hanger assembly.

### RELATED APPLICATION

This patent claims priority to U.S. Provisional Patent Application No. 61/092,113, filed Aug. 27, 2008, which is hereby incorporated herein by reference in its entirety.

### FIELD OF THE DISCLOSURE

This patent relates generally to cart assemblies and, more specifically, to cart assemblies for use with blood filtration.

### BACKGROUND

Leukoreduction refers to the process of removing leukocytes from blood or a blood component prior to a transfusion. The process of leukoreduction is often performed because blood in which leukocytes are not removed may cause adverse reactions in the recipients of such blood. Some of these adverse reactions include the recipient experiencing chills or contracting cytomegalovirus, for example.

Commonly, leukoreduction involves the transfer of blood or a blood component from a pre-filter container to a post-filter container through a tubing line having a leukoreduction filter. Passing fluid from the pre-filter container, through the filter, and into the post-filter container requires a certain degree of pressure. This pressure can be achieved by positioning the pre-filter container a predetermined vertical distance above the filter and the post-filter container and, thereafter, enabling the fluid to flow downwardly through the filter under the influence of gravity. The vertical distance between the pre-filter and post-filter containers is commonly referred to as the “head height”. To ensure that substantially all of the fluid flows through the filter and into the post-filter container, the head height must be equal to or greater than a predetermined distance.

In some instances, the pre-filter container, the filter and the post-filter container are hung on a hook of a cart assembly via the pre-filter container. To attain the predetermined distance and initiate the flow of fluid through the filter and into the post-filter container, a portion of the cart assembly on which the hook is operatively coupled is extended, thereby raising the pre-filter container relative to the post-filter container.

### SUMMARY

An example cart assembly for use with blood filtration includes a base including a recessed portion to receive one or more containers defining compartments each to receive a container of a fluid transfer system. Additionally, the base includes a plurality of transport members coupled to respective portions of the base. A plane on which a surface of the recessed portion lies is below a portion of each of the plurality of transport members. Additionally, the cart assembly includes a hanger assembly comprising a plurality of suspension members from which another container of the fluid transfer system is to be suspended and a pole to couple the base to the hanger assembly.

### BRIEF DESCRIPTION OF THE DRAWINGS

FIG. 1 depicts an example cart assembly for use with blood filtration.

FIG. 2 depicts a fluid transfer system.

FIGS. 3 and 4 depict different views of an alterative base that may be used to implement the cart assembly of FIG. 1.

FIGS. 5 and 6 depict different views of a portion of an example cart assembly having an alternative base.

FIG. 7 depicts another base that may be used to implement the cart assembly of FIG. 1.

FIGS. 8-10 depict different views of another example cart assembly for use with blood filtration.

FIGS. 11 and 12 depict different views of an example compartment that may be used to implement the example cart assembly of FIGS. 8-10.

FIGS. 13-15 depict different views of a portion of another example cart assembly having an alternative base for use with blood filtration.

FIGS. 16A-16C depict an example cart assembly in different environments.

FIG. 17 depicts an upper fluid container suspended from an example hanger assembly.

FIG. 18 depicts an example hanger assembly that may be used to implement the examples described herein.

FIGS. 19 and 20 depict different views of an example cart assembly including the hanger assembly of FIG. 18.

FIGS. 21 and 22 depict different views of an example cart assembly for use with blood filtration.

FIGS. 23-25 depict different views of an example hanger assembly that may be used to implement the examples described herein.

FIG. 26 depicts a portion of the example hanger assemblies of FIGS. 8 and 18.

FIGS. 27-33 depict different views of the example cart assembly of FIG. 21 and the fluid transfer system of FIG. 2.

### DETAILED DESCRIPTION

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness. Additionally, several examples have been described throughout this specification. Any features from any example may be included with, a replacement for, or otherwise combined with other features from other examples.

The examples described herein relate to example cart assemblies from which fluid transfer systems are to be hung during blood filtration. Specifically, the examples described herein relate to cart assemblies having a head height that enables fluid flow through the fluid transfer systems and an overall height that enables the cart assemblies to be transported through various environments having relatively low ceiling heights. Such an approach enables the cart assemblies described herein to be more efficiently and ergonomically used than some known cart assemblies.

For example, to transport some known cart assemblies through environments having relatively low ceiling heights such as, a freezer door, a person may be required to lower a portion of the known cart assembly. By lowering the portion of the known cart assembly, the head height is also decreased, which decreases and/or stops fluid flow through the fluid transfer systems. Additionally, raising and lowering the portion of known cart assemblies may be somewhat difficult for some people because of its weight, as the portion being moved is also the portion from which the fluid transfer systems are hung.

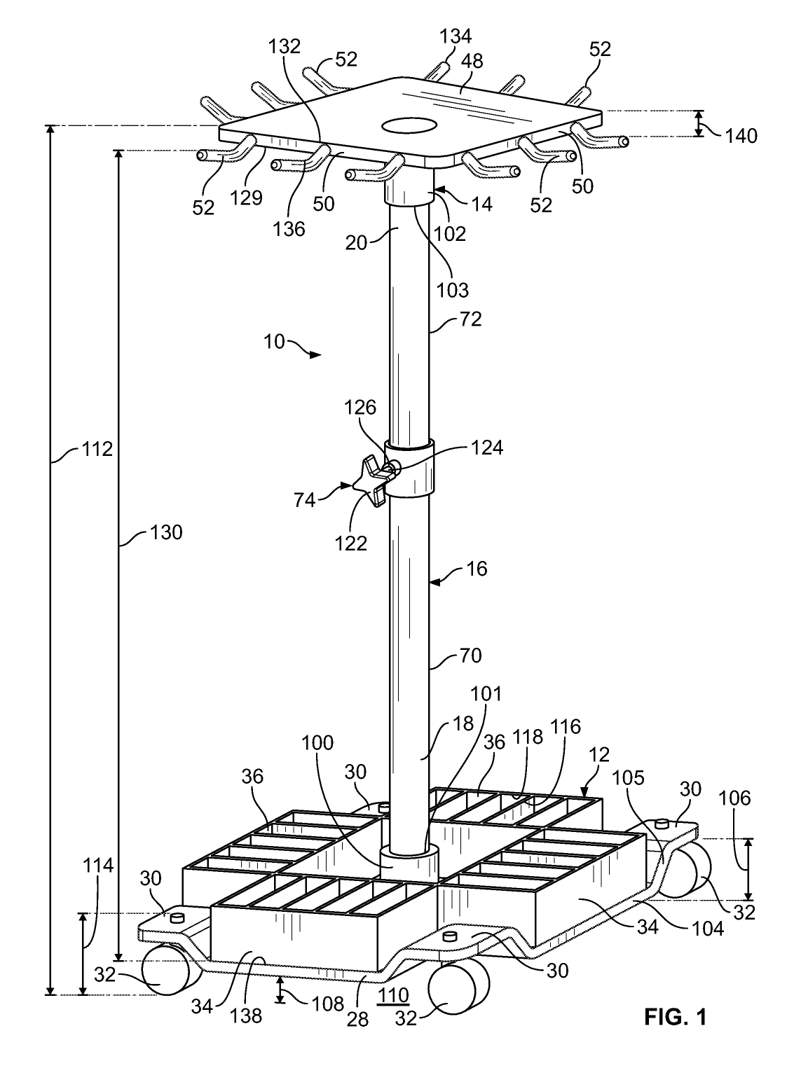

FIG. 1 illustrates an example low profile cart assembly or cart assembly 10 that includes a base 12, a hanger assembly 14 and a pole 16 that couples the base 12 to the hanger assembly 14. The base 12 includes a portion 100 defining an aperture 101 to receive a first end 18 of the pole 16. Similarly, the hanger assembly 14 includes a portion 102 defining an aperture 103 to receive a second end 20 of the pole 16 opposite the first end 18. Depending on how the cart assembly 10 is manufactured, the pole 16 may be integrally, mechanically or removably coupled to the base 12 and the hanger assembly 14, respectively.

The base 12 includes a generally square or rectangular platform 28 having a recessed portion(s) 104, corners 30 and tapered portions 105 positioned between the recessed portion 104 and the corners 30. A distance 106 between the recessed portion 104 and the corners 30 enables transport members, rollers or casters 32 to be coupled to each of the corners 30 while maintaining a particular ground clearance 108 between the recessed portion 104 and an adjacent ground 110. The ground clearance 108 may be approximately two inches to enable the cart assembly 10 to be transported on inclined surfaces without having the recessed portion 104 bottoming out the inclined surface. However, to accommodate different environments, other distances may be used. The transport members 32 enable the cart assembly 10 to be easily transported (e.g., rolled) into and out of a room or freezer in which the cart assembly 10 is to be placed. To reduce an overall height 112 of the cart assembly 10, a height 114 of each of the transport members 32 may be minimized. While the transport members 32 are depicted as casters, the transport members 32 may be wheels or rollers, for example.

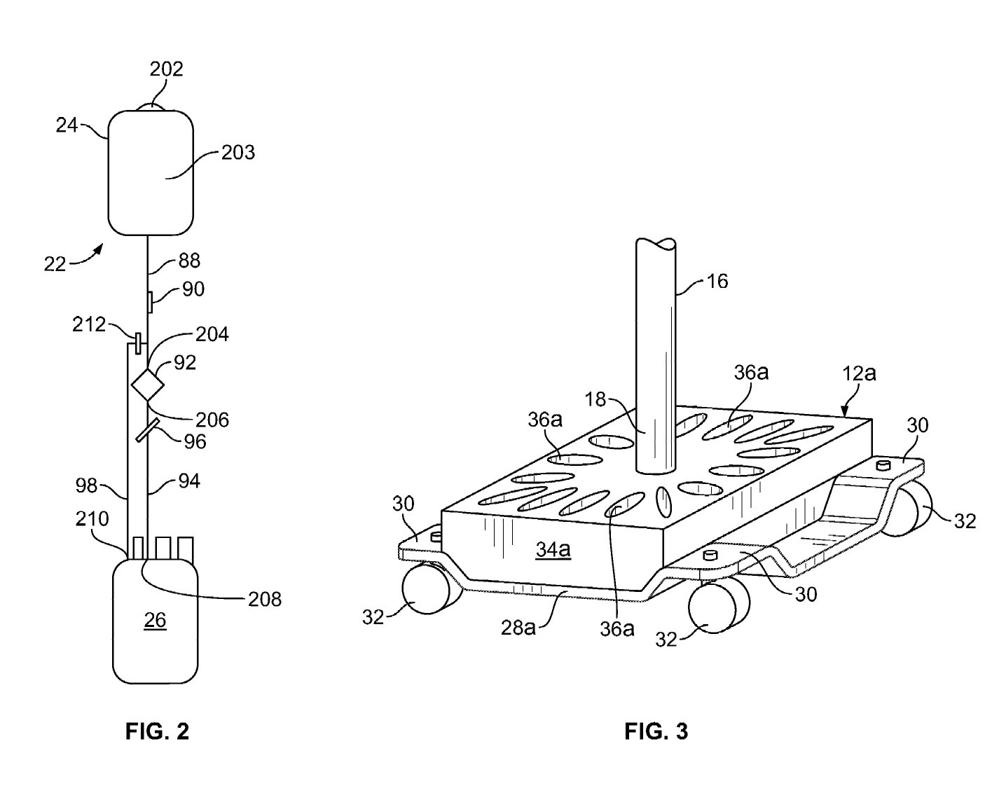

The recessed portion 104 of the base 12 is configured to receive a plurality of containers or bag holders 34 having a plurality of compartments 36. The compartments 36 are each to receive a lower fluid container or bag 26 (FIG. 2) of a fluid transfer system 22 (FIG. 2). Positioning the respective lower fluid container 26 (FIG. 2) into one of the compartments 36 decreases the likelihood that when multiple fluid transfer systems 22 (FIG. 2) are used with the cart assembly 10, that the fluid transfer systems 22 will become tangled or otherwise disorganized. The compartments 36 may be sized slightly larger than the lower fluid container 26 (FIG. 2) full of fluid. Thus, the flow of fluid into the lower fluid container 26 will not be significantly impeded by the compartment 36 in which the respective lower fluid container 26 is positioned.

To support the lower fluid container 26 in a generally upright position and enable access to the compartments 36, each of the compartments 36 includes sides 116 and 118 and a top opening 120. The containers 34 may be removably coupled to the base 12 to facilitate cleaning, replacement or to exchange the containers 34 for ones having larger or smaller compartments 36. However, the containers 34 may be integrally or otherwise coupled to the base 12.

The pole 16 includes a first portion or lower segment 70 that is telescopically coupled to a second portion or upper segment 72 to enable the length of the pole 16 to be adjusted. However, the pole 16 may only include a single portion or segment and, thus, the length of the pole 16 would be fixed in such examples. To substantially ensure alignment of the fluid transfer system 22 (FIG. 2) by preventing rotation of the second portion 72 relative to the first portion 70, the portions 70 and 72 may have non-circular cross sections (e.g., square or rectangular cross-section). However, the portions 70 and 72 may have any other suitable cross-section.

A locking mechanism 74 is provided to secure or otherwise fix the second portion 72 relative to the first portion 70. In this example, the locking mechanism 74 includes an adjustable knob 122 having an elongated member 124 extending therefrom and through a threaded aperture 126 defined by the first portion 70 of the pole 16. To adjust the height of the pole 16, a person may rotate the knob 122 (e.g., clockwise or counter clockwise) until an end (not shown) of the elongated member 124 disengages a surface 128 of the second portion 72 and, thereafter, the person may move the second portion 72 relative to the first portion 70 to a desired position. Once the second portion 72 is in the desired position, the person may rotate the knob 122 until the end of the elongated member 124 engages the surface 128 and the second portion 72 is secured relative to the first portion 70. While the locking mechanism 74 is depicted as including the knob 122 and the elongated member 128 other locking mechanisms may be used. For example, the locking mechanism 74 may be a clamp or a plurality of apertures (not shown) defined by the portions 70 and 72 that are to receive a pin (not shown) once aligned. Additionally or alternatively, the first portion 70 and/or the second portion 72 may be provided with marking or indicators to more easily enable a person to identify a head height 130 for a given pole length.

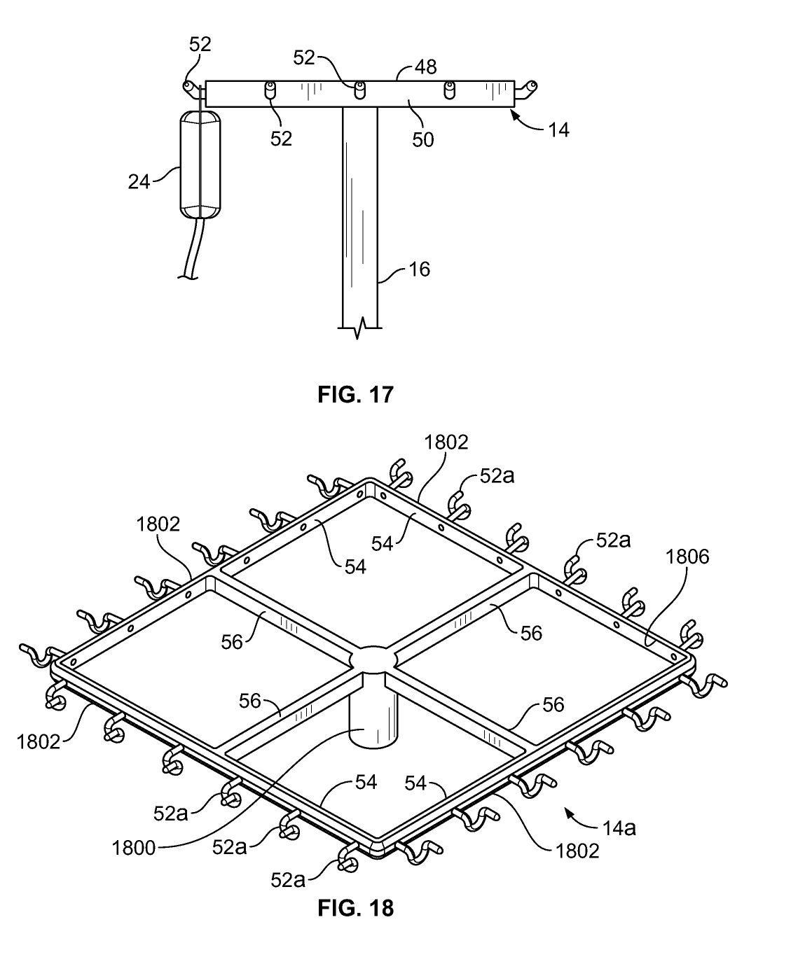

Referring collectively to FIGS. 1 and 17, opposite the base 12, the hanger assembly 14 is coupled to the second end 20 of the pole 16. To minimize the overall height 112 of the cart assembly 10, the second end 20 of the pole 16 may not extend through the hanger assembly 14 and may instead be received by the aperture 103 of the portion 102 as depicted in FIG. 1. The hanger assembly 14 includes a first surface or top surface 48, a second surface or bottom surface 129 opposite the first surface 48 and a plurality of side walls 50 positioned between the first and second surfaces 48 and 129.

Each of the side walls 50 includes a plurality of suspension members or hooks 52 extending therefrom to support a respective upper fluid container or bag 24 (FIG. 2) of the fluid transfer system 22 (FIG. 2). To maximize the head height 130 of the cart assembly 10 while minimizing the overall height 112 of the cart assembly 10, the suspension members 52 may be positioned toward an upper edge 132 of the side walls 50 such that an end 134 of the respective suspension members 52 is substantially co-planer with the first surface 48. However, the suspension members 52 may instead extend from the first surface 48 and/or the second surface 129. The suspension members 52 may be configured as hooks or fixtures to support the upper fluid container 24 (FIG. 2) via an aperture or eyelet 202 (FIG. 2) of the upper fluid container 24 (FIG. 2.).

The suspension members 52 may be positioned directly above one of the compartments 36, which enables the fluid transfer system 22 (FIG. 2) to be hung substantially vertically relative to the cart assembly 10 from one of the suspension members 52. Hanging the fluid transfer system 22 substantially vertically maximizes the head height 130 of the cart assembly 10 and minimizes the likelihood that the multiple fluid transfer systems 22 hung from the hanger assembly 14 will become tangled with one another.

The head height 130 is equal to a distance between a surface 136 of the suspension member 52 where the upper fluid container 24 (FIG. 2) is to be positioned and a bottom surface 138 of the compartment 36 on which the lower fluid container 26 (FIG. 2) is to be positioned. The overall height 112 of the cart assembly 10 is equal to distance from the ground 110 and the first surface 48 of the hanger assembly 14 or the end 134 of the suspension member 52, which ever is greater. Thus, the overall height 112 includes the ground clearance 108, the head height 130 and a distance 140 between the surface 136 of the suspension member 52 and the first surface 48 of the hanger assembly 14 or the end 134 of the suspension member 52, which ever is greater. The head height 130 may be approximately 74.0 inches, the overall height 112 may be approximately 77.0 inches, the ground clearance 108 may be approximately two inches and the distance 140 may be approximately one inch, for example. Advantageously, the cart assembly 10 having the overall height 112 of 77.0 inches and the head height 130 of 74.0 inches may be easily moved into and out of freezer doorways that are typically 78.0 inches, without lowering the hanger assembly 14 relative to the base 12 and, thus, halting or decreasing the fluid flow rate through the fluid transfer system 22.

FIG. 2 depicts the fluid transfer system 22 that may be used in connection with the cart assembly 10 (FIG. 1). The fluid transfer system 22 includes the upper fluid container 24 that is fluidly coupled to the lower fluid container 26. Specifically, the upper fluid container 24 is fluidly coupled to the lower fluid container 26 by first and second tubing lines (e.g., filter flowlines or filter tubing lines) 88 and 94 though a filter 92. The upper fluid container 24 may contain any suitable fluid 203 such as, for example, whole blood or a blood component, for example.

The upper fluid container 24 is fluidly coupled to an inlet 204 of the filter 92 via the first flow line (e.g., filter inlet flow path) 88 that includes an in-line cannula 90 that prevents fluid flow therethrough until broken. The filter 92 may contain any suitable filter media. However, if the filter 92 is a leukoreduction filter, the filter media may be suitable for processing whole blood or a blood component. Opposite the inlet 204, the filter 92 includes an outlet 206 that is fluidly coupled to an inlet port 208 of the lower fluid container 26 by the second tubing line 94. In some examples, the lower fluid container 26 is a flexible bag made of a plastic material such as, polyvinyl chloride (PVC), while the second tubing line 94 may be made of flexible tubing.

The lower fluid container 26 additionally includes a second port 210 to fluidly couple the lower fluid container 26 to the first tubing line 88 via a bypass tubing line 98. As with the first and second tubing lines 88 and 94, the bypass tubing line 98 may be made of a flexible tubing.

To control the flow of fluid from the filter 92 to the lower fluid container 26, the fluid transfer system 22 includes a first filter line clamp or closure device 96. Specifically, the filter first closure device 96 controls the fluid flow into the lower fluid container 26. Similarly, to control the flow of fluid from the lower fluid container 26 to the first tubing line 88 via the bypass tubing line 98, the fluid transfer system 22 includes a second filter line clamp or closure device 212. While the examples described herein refer to the fluid transfer system 22, other fluid transfer systems may be used instead.

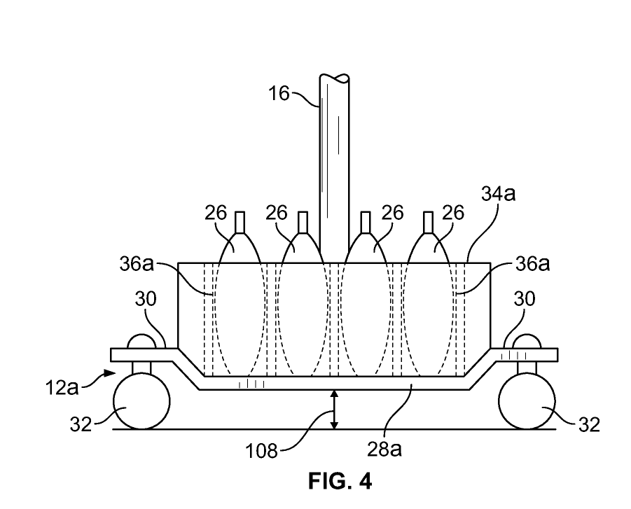

FIGS. 3 and 4 depict a base 12a having a platform 28a that is substantially similar to the base 12 of FIG. 1. However, instead of including the plurality of containers 34, the base 12a of FIGS. 3 and 4 includes a single container or bag holder 34a. The container 34a includes a plurality of compartments 36a that are to each receive one of the lower fluid containers 26 (FIG. 2). As with compartments 36 of the container 34 of FIG. 1, the compartments 36a may be sized slightly larger than the lower fluid container 26 (FIG. 2) full of fluid to prevent the restriction of fluid flow into the lower fluid container 26 (FIG. 2). While the compartments 36 and/or 36a are described to be sized to receive one of the lower fluid containers 26 (FIG. 2), the compartments 36 and/or 36a may alternatively be sized to receive more than one of the lower fluid containers 26 (FIG. 2).

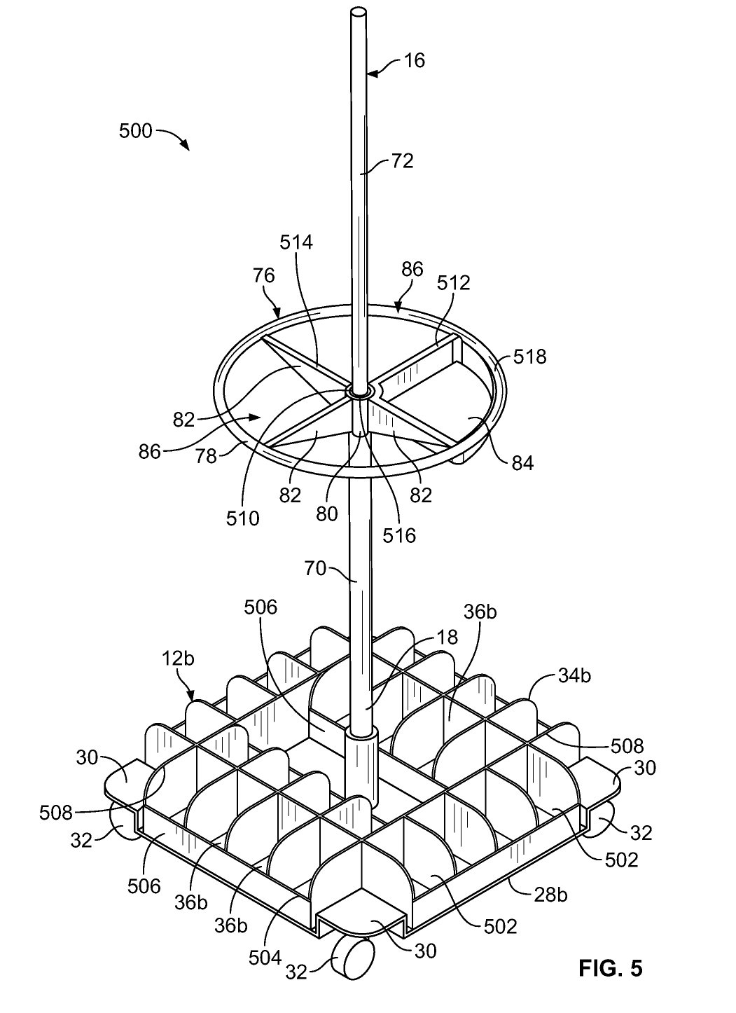

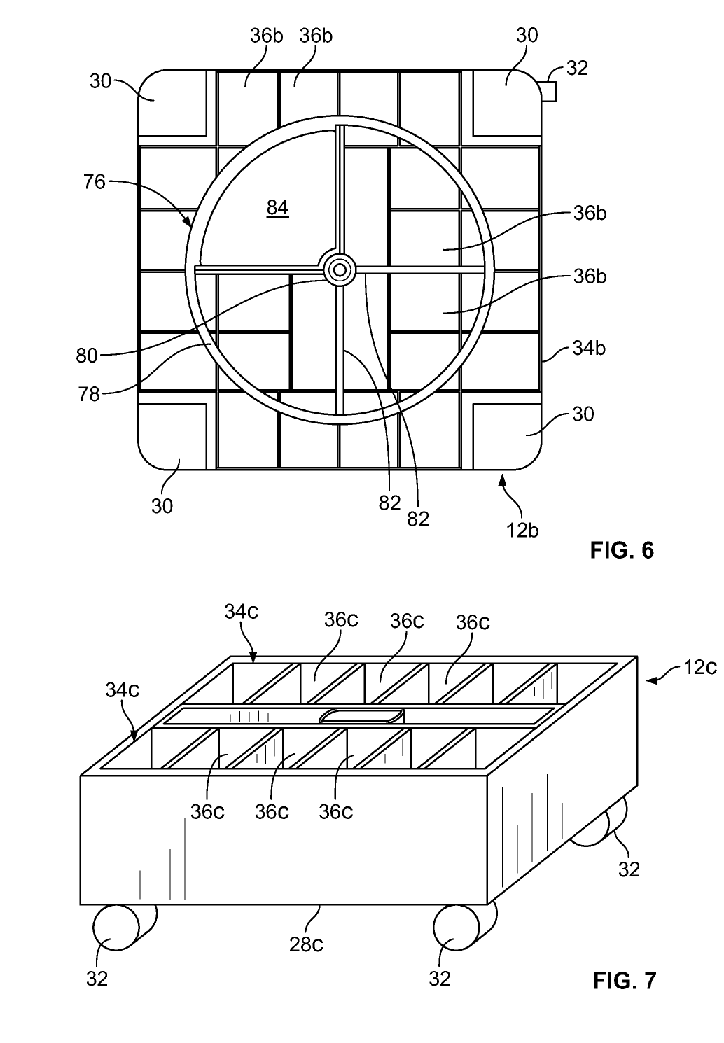

FIGS. 5 and 6 depict a portion of a low profile cart assembly or cart assembly 500 that includes a base 12b having a platform 28b and the pole 16 that are substantially similar to the base 12 and the pole 16 of FIG. 1. However, instead of including the plurality of containers 34, the base 12a of FIGS. 5 and 6 includes a single container or bag holder 34b having a plurality of compartments 36b. In some examples, the base 12 may be approximately 27.0 inches by 27.0 inches or less and the compartments 36 may be approximately 4.0 inches by 5.0 inches. However, the base 12 and/or the compartments 36 may be any other suitable size.

Additionally, the compartments 36b also include a side opening 502 defined by an edge 504 of a side wall 506 at a distance from a top surface 508 of the compartments 36b. Providing the compartments 36b with the side opening 502 may enable a person to more easily place the lower fluid container 26 (FIG. 2) into the respective compartment 36b. Additionally, providing the compartments 36b with the side opening 502 enables a person to more easily view an amount of fluid in the lower fluid container 26 and/or any potential issues (e.g., fluid spills) with the respective lower fluid container 26. In some examples, the side wall 506 may have a height of approximately 2.5 inches.

The pole 16 of the cart assembly 500 includes a handle 76 having a collar or portion 80 defining an aperture 510 through which the pole 16 extends. The handle 76 may be coupled to the pole 16 at any suitable position along the pole 16 such as, for example 35.0 inches from an adjacent ground. In some examples, the position of the handle 76 along the pole 16 may be tailored to a comfortable height for the person using the cart assembly 500. Additionally, the handle 76 includes a gripping portion or annular member 78 and crossbeams 82 positioned between the collar 80 and the annular member 78. The annular member 78 surrounds the pole 16, thereby enabling a person to grip and maneuver the annular member 78 from any position around the cart assembly 500. However, the handle 76 may be any other shape or size depending on the particular application.

To enable objects or supplies to be stored on the cart assembly 500, the handle 76 includes a tray 84 that may be positioned in any opening 86 defined by adjacent crossbeams 82, a portion of the collar 80 and a portion of the annular member 78. In some examples, each of the opening 86 may be substantially similar to one another. However, the openings 86 may be differently sized. To secure the tray 84 relative to the handle 76, the tray 84 may include a lip 512 that engages upper edges 514, 516 and 518 of the adjacent crossbeams 82, the portion of the collar 80 and the portion of the annular member 78. In some examples, the tray 84 and the respective opening 86 may be sized such that the tray 84 snaps into position. While the cart assembly 500 is depicted as including one tray 84, the cart assembly 500 may include up to four trays. However, depending on the number of crossbeams 82, any number of openings may be defined to receive a corresponding tray (e.g., 1, 2, 3, etc.).

FIG. 7 depict a base 12c having a platform 28c that is substantially similar to the base 12 of FIG. 1. However, instead of including the plurality of containers 34 that are removably coupled to the platform 28, the base 12c of FIG. 7 includes the platform 28c that is integrally coupled to a container 34c having a plurality of compartments 36c. Additionally, in contrast to the base 12 of FIG. 1, the platform 28c is not provided with the corners 30. Thus, a ground clearance 702 of the base 12c may be greater than the ground clearance 108 of the base 12 of FIG. 1. However, the footprint (e.g., the floor space occupied by the base 12c) may be relatively smaller as compared to the base 12 of FIG. 1. Therefore, depending on the environment in which the cart assembly is to be used, any of the examples described herein may be utilized.

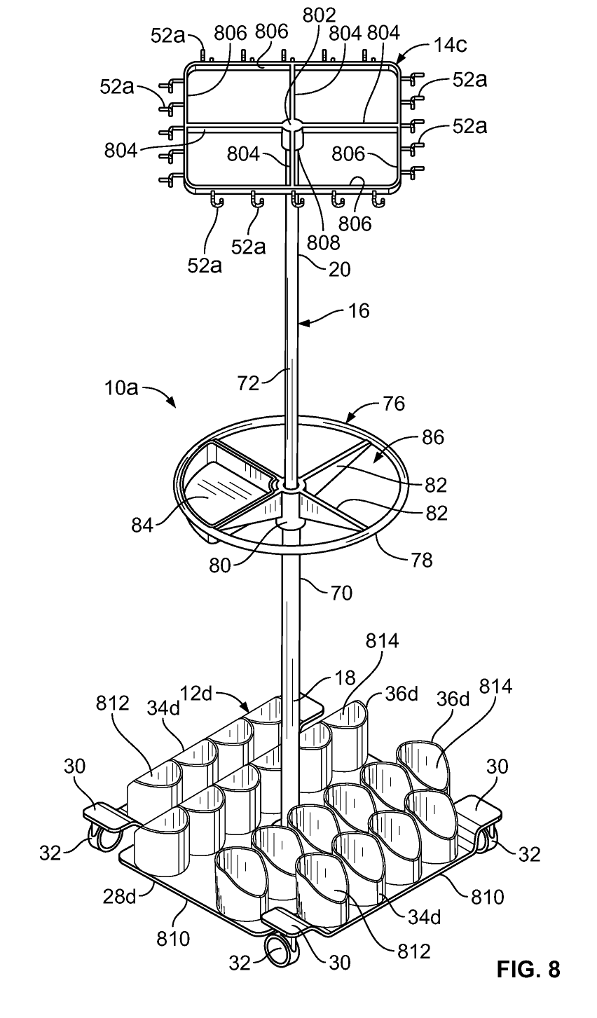

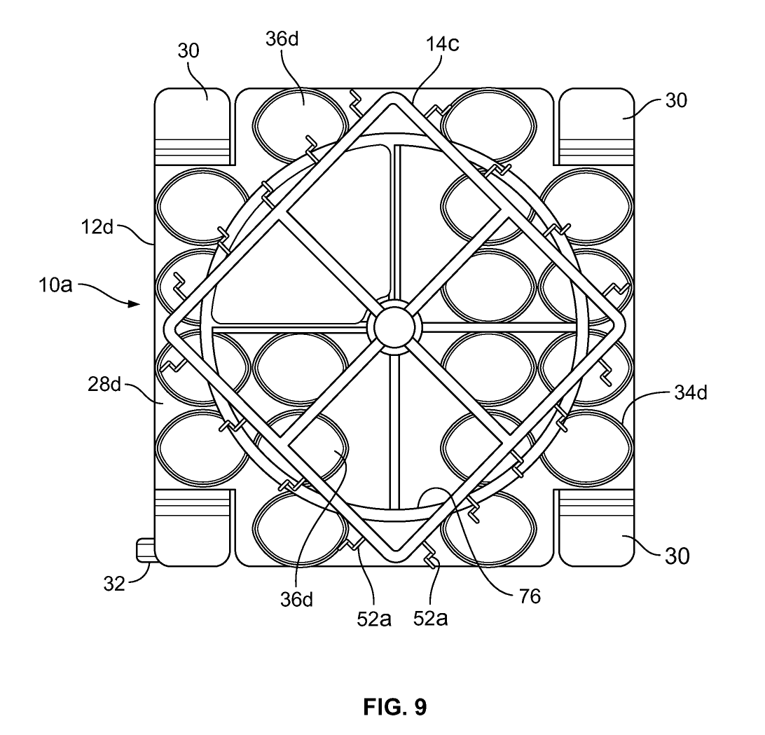

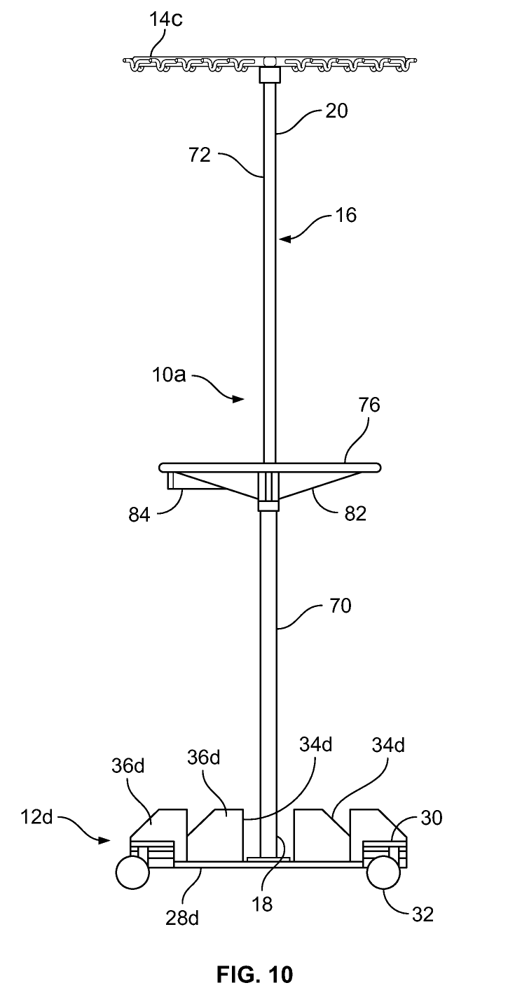

FIGS. 8-10 depict a low profile cart assembly or cart assembly 10a having a base 12d. However, in contrast to some of the examples described above, the base 12d includes a plurality of containers or bag holders 34d each having an oblong or ovoid shaped compartment 36d to receive one of the lower fluid containers 26 (FIG. 2). In some examples, the base 12 may be approximately 26.0 inches by 26.0 inches. However, the base 12 may be any other suitable size.

The cart assembly 10a includes a hanger assembly 14c having a portion 802 from which respective crossbeams 804 extend. Additionally, the hanger assembly 14c includes a frame or beams 806 that surround the portion 802 between which the crossbeams 804 are positioned. To couple the hanger assembly 14c to the pole 16, the portion 802 defines an aperture 808 that receives the second end 20 of the pole 16.

Because the base 12d includes first rows 812 of the compartments 36d and second rows 814 of the compartments 36d, some of suspension members 52a may not be positioned directly above the corresponding compartment 36d. Such a configuration enables the cart assembly 10b to accommodate more fluid transfer systems 22 while still enabling adequate fluid flow through the fluid transfer systems 22 to be suspended from the suspension members 52a. Additionally, the configuration of the suspension members 52a relative to the cart assembly 10a enables the suspensions members 52a to be readily accessible to a person hanging the upper fluid containers 24 from the respective suspension members 52a.

To decrease the size footprint of the cart assembly 10a, the hanger assembly 14c may not extend beyond a perimeter 810 of the base 12d, for example.

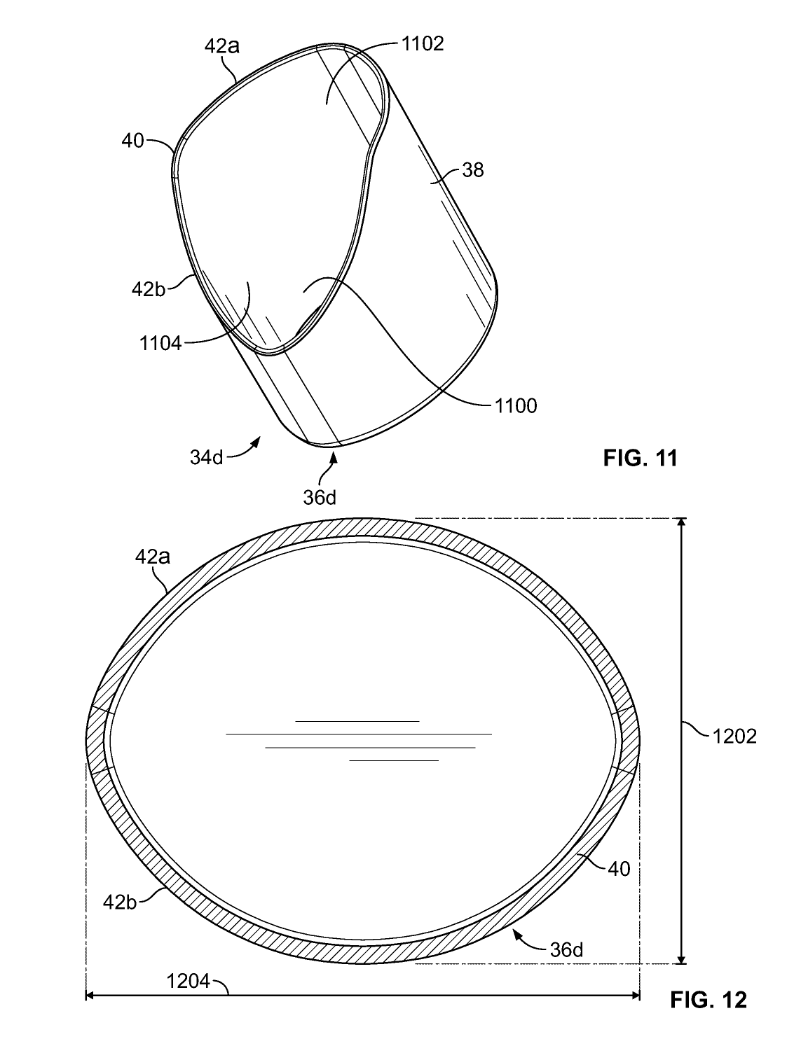

FIGS. 11 and 12 depict an enlarged view of one of the containers 34d of FIGS. 8-10. To support the lower fluid container 26 (FIG. 2) in a generally upright position and enable access to the compartments 36d, the compartment 36d includes side walls 38 having a lip 40 defining an opening 1100 that includes a top opening 1102 and a side opening 1104. The side walls 38 and/or the lip 40 includes a rear portion or first portion 42a that may be substantially flat or planer and a front portion or second portion 42b that tapers toward a platform 28d of the base 12d from the first portion 42a. As discussed above, providing each of the compartments 36d with the top opening 1102 and the side opening 1104 may enable a person to more easily place the lower fluid container 26 (FIG. 2) into the respective compartment 36d. Additionally, providing the compartments 36b with the openings 1102 and 1104 may enable a person to more easily view an amount of fluid in the lower fluid container 26 and/or any potential issues (e.g., fluid spills) with the respective lower fluid container 26. In some examples, the compartments 36d may have a width 1202 of approximately four inches and a length 1204 of approximately five inches. However, the compartments 36f may have any other suitable size.

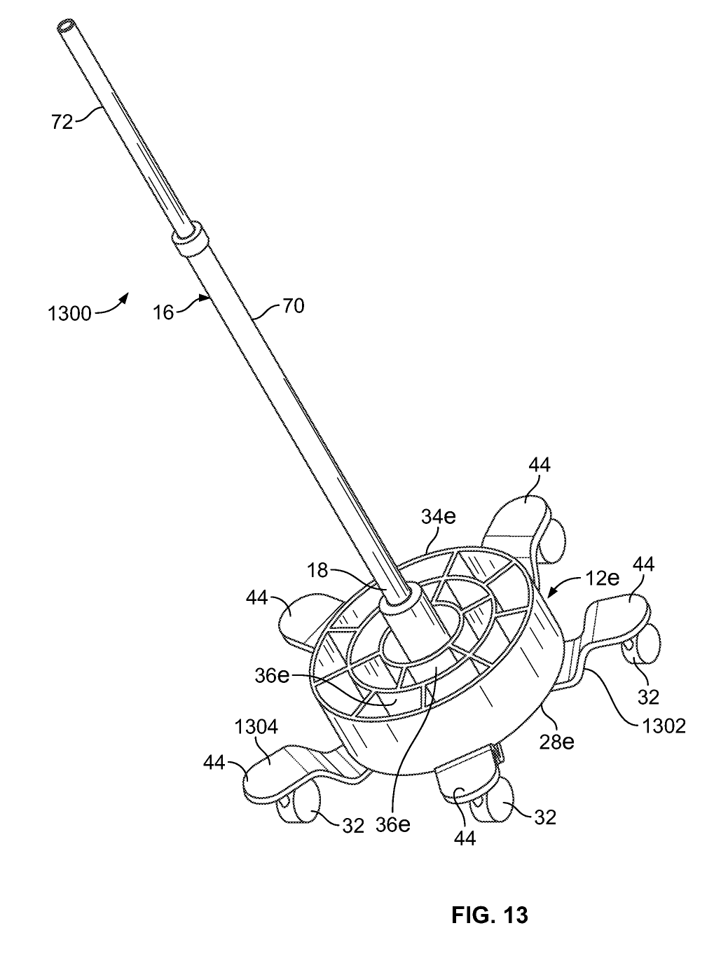

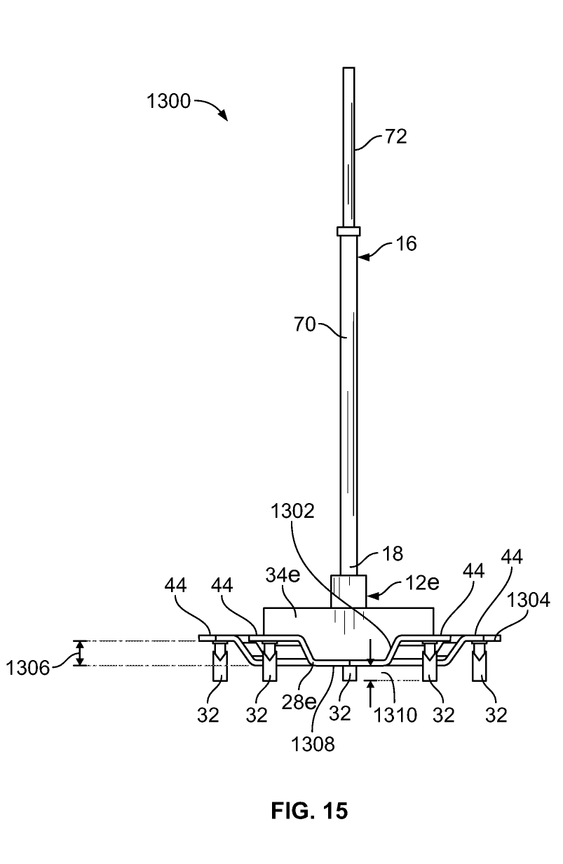

FIGS. 13-15 depict a portion of a low profile cart assembly or cart assembly 1300 that includes a base 12e and the pole 16. In contrast to the substantially square or rectangular platforms described above, a platform 28e of FIGS. 13-15 is substantially circular and includes a plurality of radial extensions or feet 44. In some examples, a distance 1400 between the pole 16 and an end 1401 of radial extensions 44 is approximately 15.0 inches. Each of the radial extensions 44 includes a tapered portion 1302 and a planer portion 1304 onto which one of the transport members 32 is coupled. A distance 1306 between a recessed portion 1308 of the base 12e and the planer portion 1304 of the radial extension 44 enables the transport members 32 to be coupled to each of the planer portions 1304 while maintaining a particular ground clearance (e.g., an effective ground clearance) 1310 between the recessed portion 1308 and an adjacent ground 1312. As discussed above, the ground clearance 1310 may be approximately two inches, but any other suitable ground clearance may be used instead (e.g., 1.5 inches, 2.5 inches, 3.0 inches, etc.) depending on the environment in which the cart assembly 1300 is to be used.

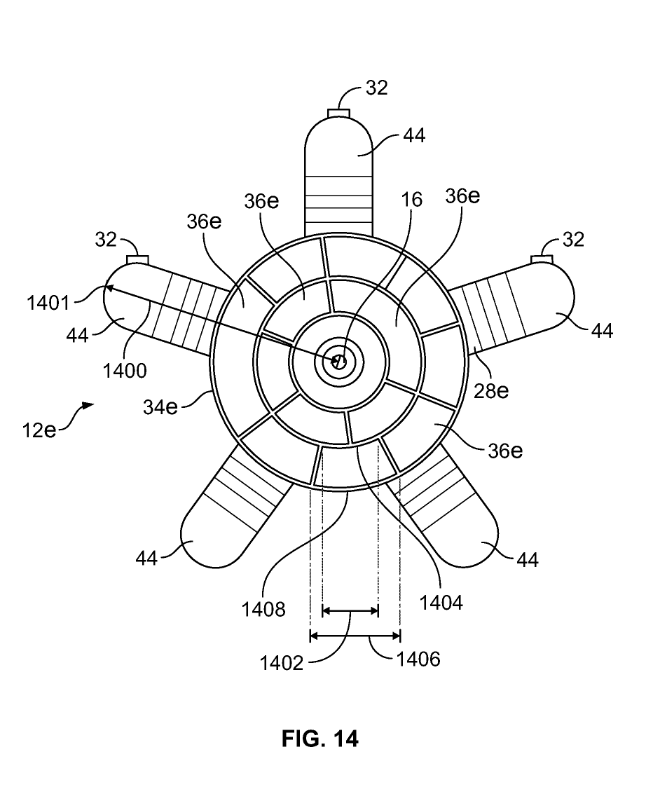

The recessed portion 1308 of the base 12e is configured to receive a container or bag holder 34e having a plurality of compartments 36e. In this example, the compartments 36e have an arcuate shaped and are each to receive one of the lower fluid containers 26 (FIG. 2). As shown in FIG. 14, in some examples, a distance 1402 between an inner portion 1404 of the compartments 36e may be approximately 3.57 inches and a distance 1406 between an outer portion 1408 of the compartments 36e may be approximately 5.27 inches.

The compartments 36e may be sized slightly larger than the lower fluid container 26 (FIG. 2) full of fluid. Thus, the flow of fluid into the lower fluid container 26 will not be significantly impeded by the compartment 36 in which the respective lower fluid container 26 is positioned. While the cart assembly 1300 is depicted with the base 12e, any of the example bases described herein may alternatively be used with the cart assembly 1300. Additionally or alternatively, other size and/or shape compartments 36e may be used instead of those depicted in FIGS. 13-15.

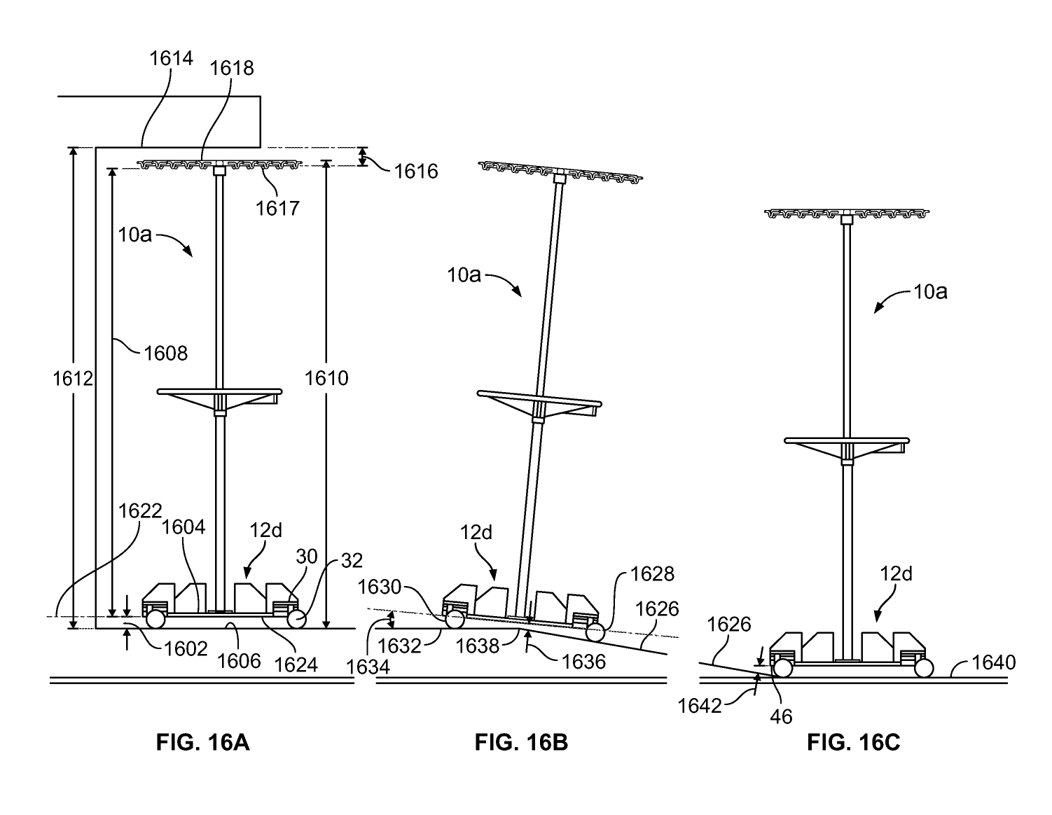

FIGS. 16A-16C depict different situations that the cart assembly 10a of FIGS. 8-10 may be exposed to in a hospital or fluid processing environment. Some results indicate that a ground clearance 1602 between a recessed portion 1604 of the base 12d and an adjacent ground 1606 of approximately two inches enables the cart assembly 10a to be easily transported in a variety of environments, maintain a head height 1608 of approximately 74.0 inches and an overall height 1610 of approximately 77.0 inches.

FIG. 16A depicts the cart assembly 10a in an area in which a distance 1612 between the ground 1606 and a ceiling or door frame 1614 is relatively short. As discussed above, some doorways in which the cart assembly 10a may be required to be transported though may be approximately 78.0 inches while the suggested head height 1608 of the fluid transfer systems 22 (FIG. 2) may be approximately 74.0 inches. Thus, in this example, for the cart assembly 10a to clear the door frame 1614 without decreasing the head height 1608 and disrupting fluid flow through the fluid transfer system 22, the ground clearance 1602 between the recessed portion 1604 of the base 12d and the adjacent ground 1606 and a distance 1616 between a surface 1617 on a suspension member 1618 on which the upper fluid container 24 is to be hung and the door frame 1614 must be less than four inches, for example. Such a configuration enables the overall height 1610 of the cart assembly 10a to be less than 78.0 inches. Advantageously, to minimize the ground clearance 1602 while enabling the transport members 32 to have a reasonable diameter, the corners 30 may be elevated relative to the recessed portion 1604 such that a plane 1622 on which a bottom surface 1624 of the recessed portion 1604 lies is below a portion of each of the transport members 32.

FIG. 16B depicts a situation in which the cart assembly 10a is being transported on an inclined surface or ramp 1626. Specifically, first transport members (one of which is indicated by reference number 1628) are positioned on the inclined surface 1626 while second transport members (one of which is indicated by reference number 1630) are positioned on a relatively flat surface 1632. Generally, as an angle 1634 of the cart assembly 10a relative to the relatively flat surface 1632 increases, a ground clearance 1636 between the bottom surface 1624 of the recessed portion 1604 and an edge 1638 that separates the inclined surface 1626 and the relatively flat surface 1632 decreases. Thus, depending on the environment in which the cart assembly 10a is to be used, the ground clearance 1602 may be tailored accordingly to prevent the bottom surface 1624 from bottoming out when the cart assembly 10a is transported on inclined surfaces while still providing the cart assembly 10a with the least amount of ground clearance 1602 possible. In some examples, the ground clearance 1636 may be approximately 0.99 inches.

FIG. 16c depicts another situation in which the cart assembly 10a is being transported on the inclined surface 1626. Specifically, a majority of the cart assembly 10a is positioned on a relatively flat surface 1640. However, an end 46 of the cart assembly 10a is extending over the inclined surface 1626, which decreases a ground clearance 1642 between the end 46 and the inclined surface 1626 as compared to the ground clearance 1602 (FIG. 16A). Thus, depending on the environment in which the cart assembly 10a is to be used, the ground clearance 1602 may be tailored accordingly to prevent the end 46 from bottoming out when the cart assembly 10a is transported on inclined surfaces, for example. In some examples, the ground clearance 1642 may be approximately 1.56 inches.

FIG. 18 depicts an example hanger assembly 14a that is similar to the hanger assembly 14 of FIG. 1 and may be used in connection with any of the examples described herein. However, instead of having the first surface 48 as in the hanger assembly 14 of FIG. 1, the hanger assembly 14a of FIG. 18 includes a portion 1800 from which respective crossbeams 56 extend. Additionally, the hanger assembly 14a includes a frame or beams 54 that surround the portion 1800 between which the crossbeams 56 are positioned.

To enable more of the upper fluid containers 24 to be hung on the respective suspensions members 52a, each side 1802 of the frame 54 includes six of the suspension members 52a as opposed to three suspension members 52 as shown in FIG. 1. However, each side 1802 of the frame 54 may include any number of the suspension members 52a (e.g., 1, 2, 3, 4, etc.). Additionally or alternatively, one or more of the sides 1802 may have a first number of the suspension members 52a while the other sides 1802 may have different numbers of the suspension members 52a.

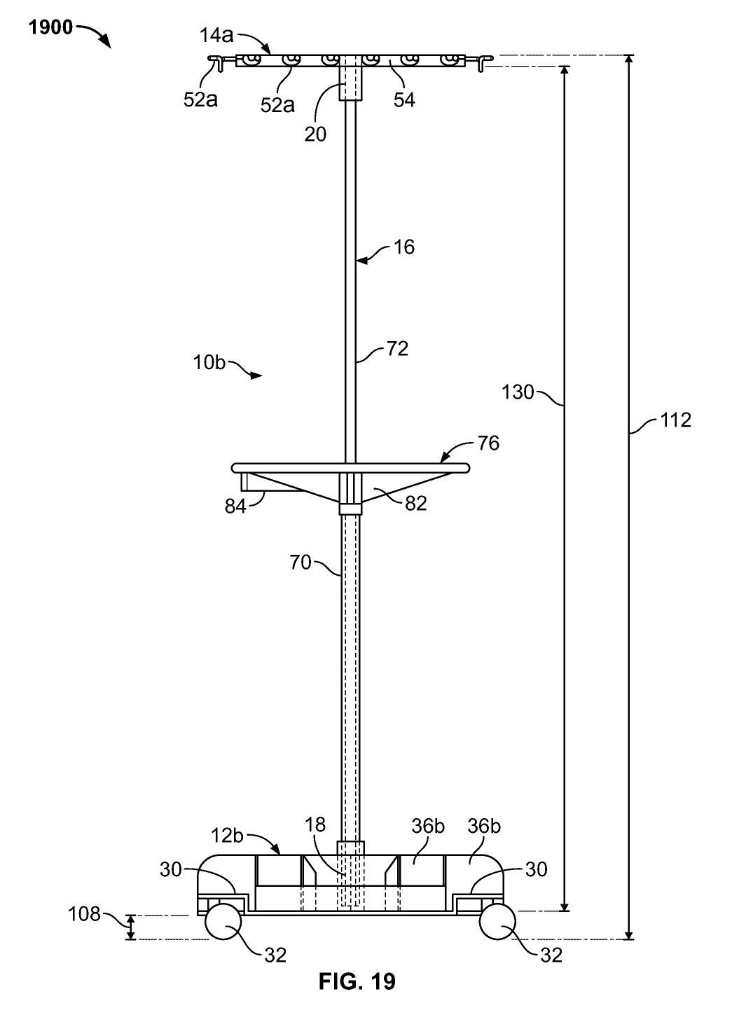

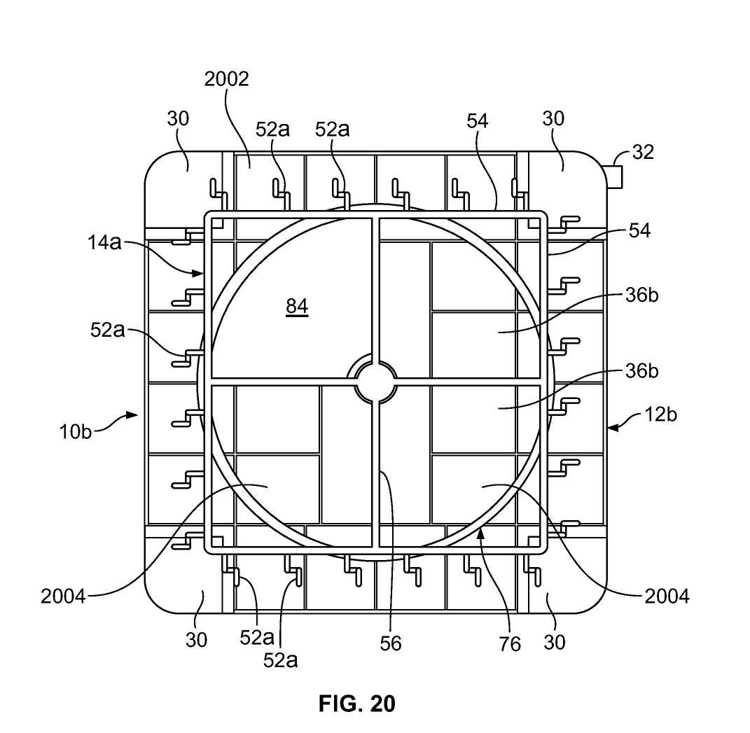

Providing the hanger assembly 14a with six of the suspension members 52a per side 1802 corresponds to the base 12b of FIGS. 19 and 20 having twenty four compartments 36b. However, the number of the suspension members 52a may be less than or greater than the number of the compartments 36b provided.

FIGS. 19 and 20 depict a low profile cart assembly or cart assembly 1900 including the hanger assembly 14a of FIG. 18 and the base 12b of FIGS. 5 and 6. Because the base 12b includes a peripheral row 2002 of the compartments 36b and inner rows 2004 of the compartments 36b, some of the suspension members 52a may not be positioned directly above the corresponding compartment 36b. Such a configuration enables the cart assembly 10b to accommodate more fluid transfer systems 22 while still enabling adequate fluid flow through all of the fluid transfer systems 22 suspended from the corresponding suspension members 52a. However, the suspension members 52a may be differently positioned on the frame 54 such that each of the suspension members 52a is directly above the corresponding compartment 36b. For example, some of the suspension members 52a may be coupled to an outer surface 1804 of the frame 54, as shown, and some of the suspension members 52a may be coupled to an inner surface 1806 of the frame 54.

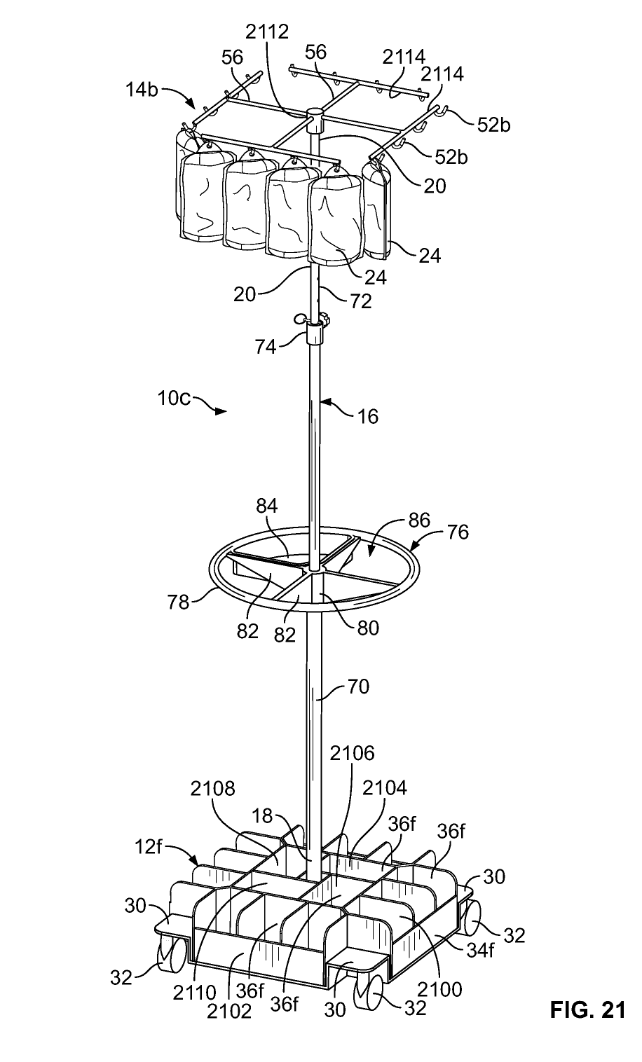

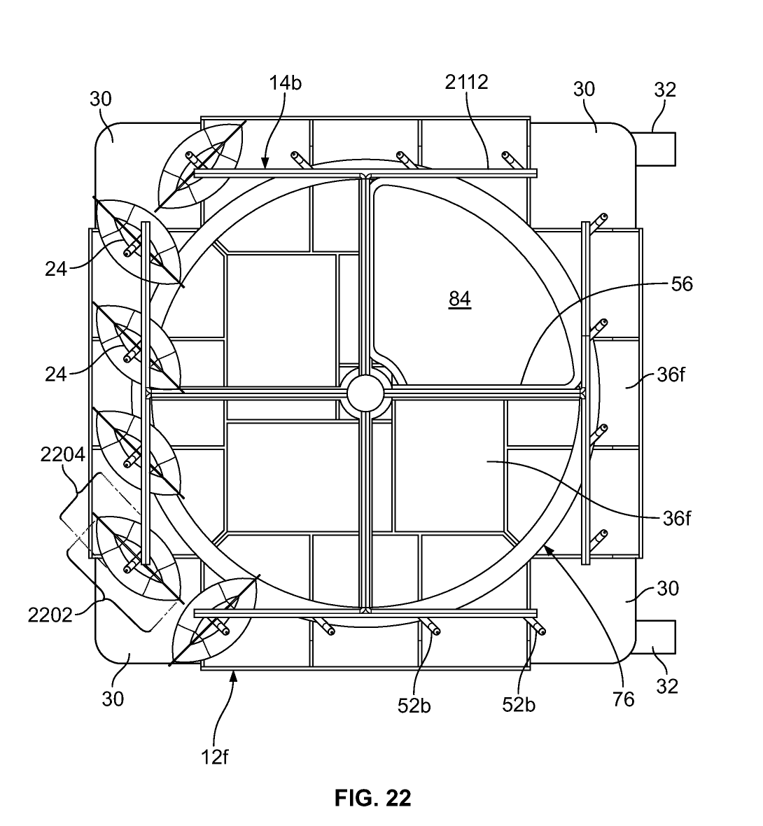

FIGS. 21 and 22 depict an example hanger assembly 14c that includes an example base 12f, an example hanger assembly 14b and the pole 16 that couples the base 12f to the hanger assembly 14b. The base 12f is similar to the base 12b of FIG. 5. However, in contrast to the base 12b of FIG. 5, the base 12f includes a container 34f having a peripheral row 2100 of compartments 36f having three compartments 36f per side 2102 as opposed to four compartments 36f per side. Additionally, the base 12f includes four compartments 2104-2110 alternatively arranged around the pole 16. In some examples, the base 12f may be approximately 21.0 inches by 21.0 inches and the compartments 36f may be approximately 4.00 inches by 5.00 inches. However, the base 12f and/or the compartments 36f may be any other suitable size.

Opposite the base 12, the hanger assembly 14b is coupled to the second end 20 of the pole 16. The hanger assembly 14b includes a portion 2112 from which respective crossbeams 56 extend. Additionally, the hanger assembly 14b includes a plurality of beams or members 2114 each of which is coupled to a corresponding crossbeam 56. In contrast to the examples described above, each of the beams 2114 is independently supported by its respective crossbeam 56. The suspension members 52a are configured to enable a portion of the upper fluid container 24 hanging therefrom to be partially positioned beneath the respective beam 2114. Thus, when a low profile cart assembly or cart assembly 10c is transported, the interaction between the upper fluid container 24 and the respective beam 2114 may further ensure that the upper fluid container 24 does not inadvertently come off of the suspension member 52a. Additionally, because a width 2202 of the upper fluid container 24 is greater than a thickness 2204 of the upper fluid container 24, angling the upper fluid containers 24 relative to the hanger assembly 14b enables more fluid transfer systems 22 to be hung from the hanger assembly 14b.

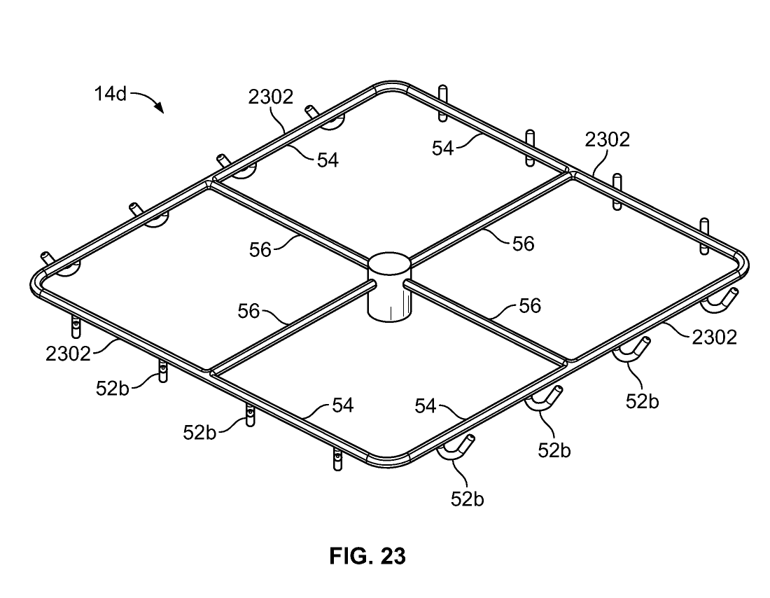

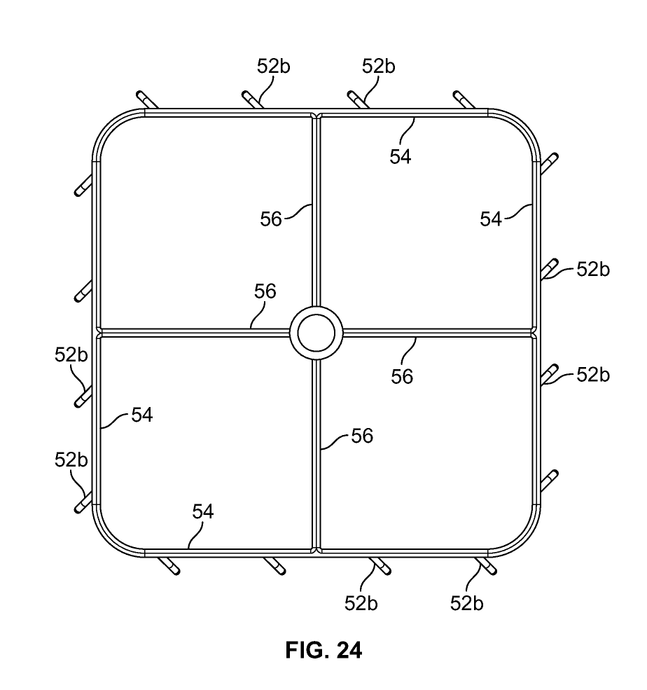

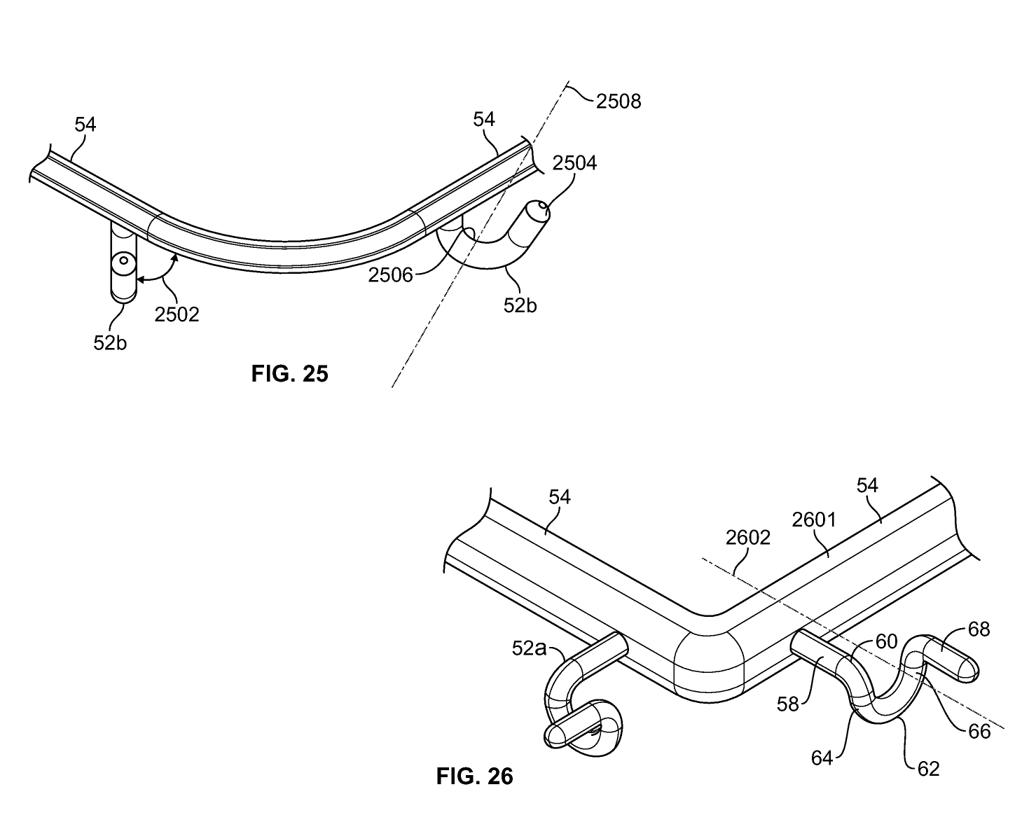

FIGS. 23 and 24 depict an example hanger assembly 14d that is similar to the hanger assemblies 14c of FIGS. 8-10 and 14a of FIGS. 18-20 and may be used in connection with any of the examples described herein. However, in contrast to the hanger assemblies described above, the hanger assembly 14d includes four suspensions member 52b per side 2302. Additionally, the suspension members 52b are differently configured as compared to the suspension members 52a of FIG. 8-10 and FIGS. 18-20. Turning to FIG. 25, the suspension member 52b has a “J” shape and is coupled to the frame 54 at an angle or non-perpendicular angle 2502. To place the upper fluid container 24 onto the suspension member 52b, a person may align an end 2504 of the suspension member 52b with the aperture 202 of the upper fluid container 24. Thereafter, the person moves the end 2504 through the aperture 202 and, thus, the upper fluid container 24 is then supported on a surface 2506 of the suspension member 52b. Because the suspension member 52b is coupled to the frame 54 at the angle 2502, the upper fluid container 24 may lie along a plane 2508, which increases the number of fluid transfer systems 22 able to be hung from the hanger assembly 14d and enables the frame 54 to substantially ensure that the fluid transfer systems 22 do not inadvertently fall off of the respective suspension member 52b.

FIG. 26 depicts the suspension member 52a of the hanger assembly 14c of FIGS. 8-10 and FIGS. 18-20. The suspension member 52a includes a generally straight anchored arm or first member 58 that extends from the respective portion of the frame 54. Additionally, the suspension member 52a includes a “U” shaped support member 62 that extends from an end 64 of the member 58. The support member 62 may be substantially parallel to the respective portion of the frame 54 and may be approximately one inch below a top surface 2601 of the frame 54. Opposite the first member 58, a second member 68 is coupled to an end 66 of the support member 62. The second member 68 may be substantially parallel to the first member 58. The members 58, 64 and 68 may be integrally or mechanically coupled together. The parallel configuration of the support member 62 relative to the frame 54 enables the lower fluid container 26 hung from the suspension member 52a to lie along a plane 2602 and, thus, partially beneath the frame 54. While the suspension member 52a includes the members 58, 64 and 68, some or all of the members 58, 64 and/or 68 may be differently configured or omitted. For example, while the second member 68 may at least partially guide the upper fluid container 24 onto the suspension member 52a, the second member 68 may be omitted. Additionally, while the support member 62 is depicted as substantially parallel to the frame 54, the support member 62 may be arranged at any suitable angle relative the frame 54.

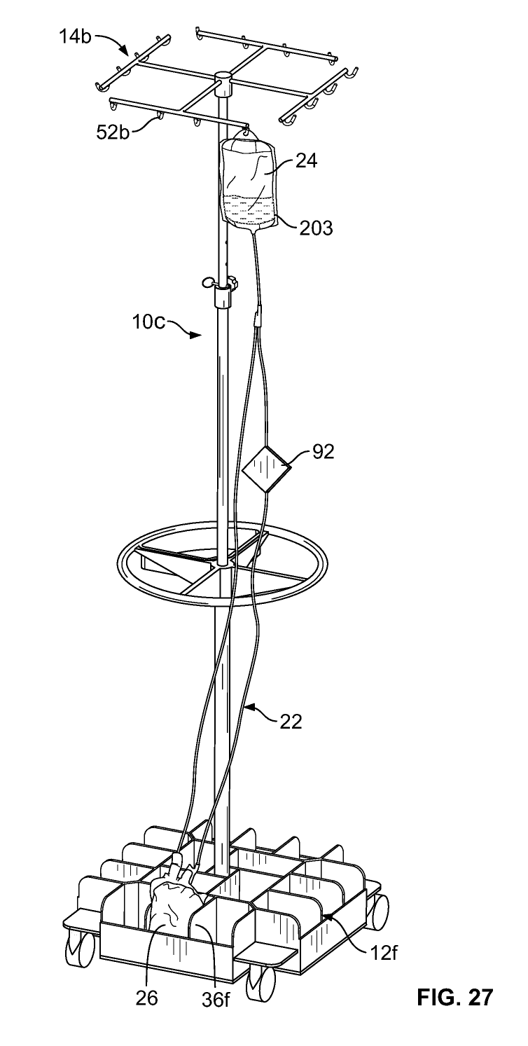

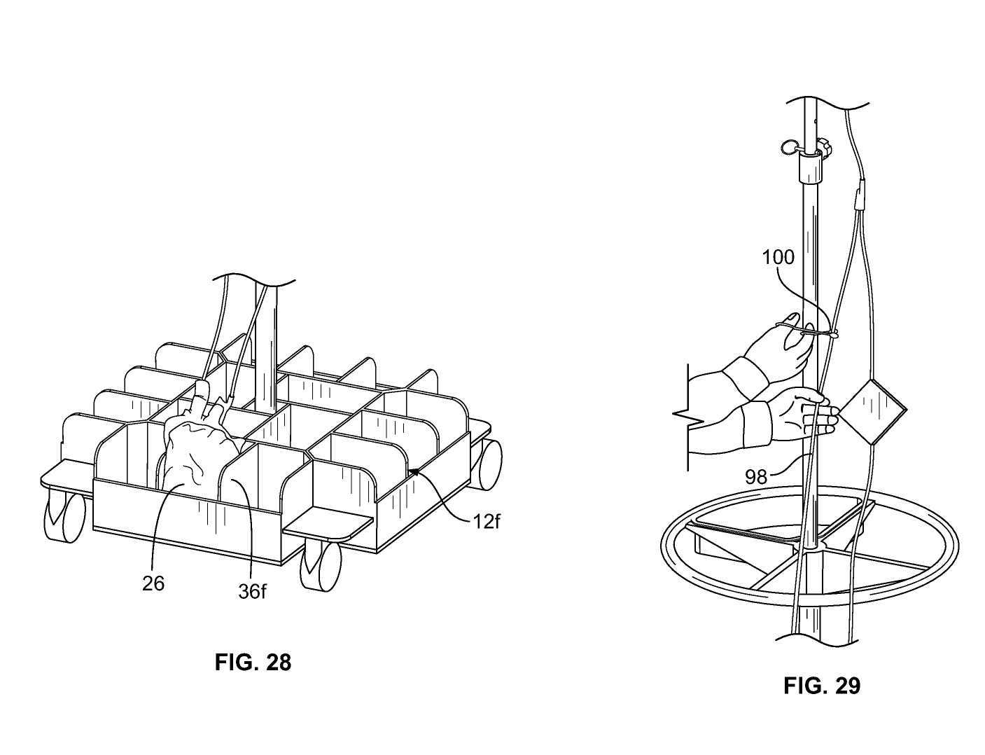

FIGS. 27-36 depict a method of using the fluid transfer system 22 of FIG. 2 with the cart assembly 10c. FIG. 27 depicts the upper fluid container 24 suspended from one of the suspension members 52b containing the fluid 203 that may be, for example, unfiltered whole blood. Opposite the upper fluid container 24, the corresponding lower fluid container 26 is positioned in the compartment 36f of the base 12f (shown most clearly in FIG. 28).

In some examples, the lower fluid container 24 may at least partially rest on a bottom surface of the compartment 36f. However, in other examples, the lower fluid container 24 may be partially suspended within the compartment 36f via the tubing lines 88 and 94. In examples in which the lower fluid container 24 is partially suspended within the compartment 36f, the lower fluid container 26 is substantially ensured to be upright within the compartment 36f and, thus, fluid flow into the lower fluid container 26 and, specifically, the inlet port 208, will not be hindered.

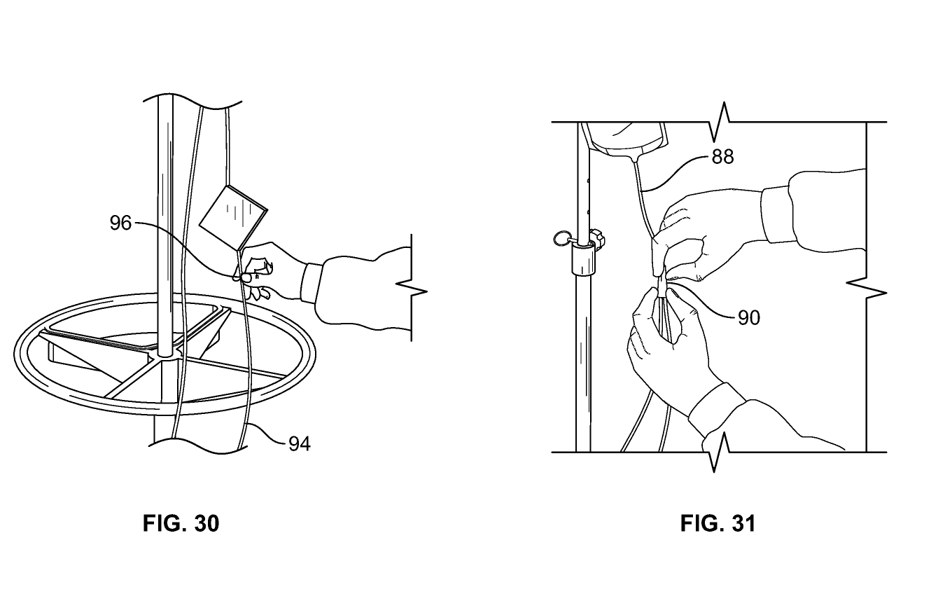

As shown in FIG. 29, the second closure device 212 may then be coupled to the bypass tubing line 98. To prevent fluid flow through the bypass tubing line 98, the second closure device 212 may be initially closed. Turning to FIGS. 30 and 31, to initiate fluid flow through the fluid transfer system 22 and, specifically, the filter 92, the first closure device 96 may be disengaged from the second tubing line 94 and, thereafter, the cannula 90 in the first tubing line 88 may be broken. As described above, the fluid 203 flows through the filter 92 and through the fluid transfer system 22 under the influence of gravity.

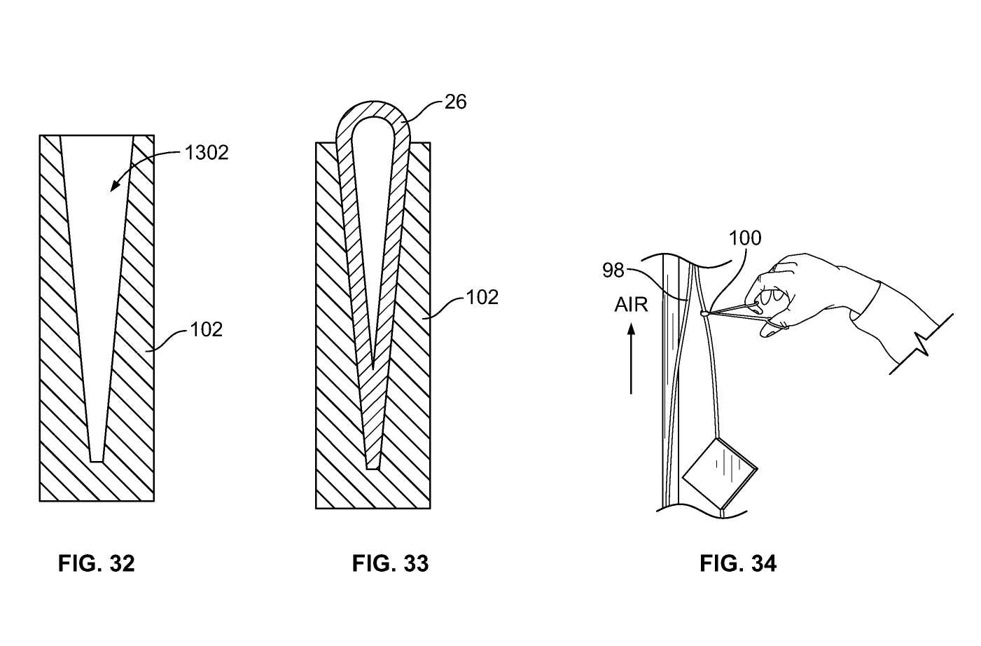

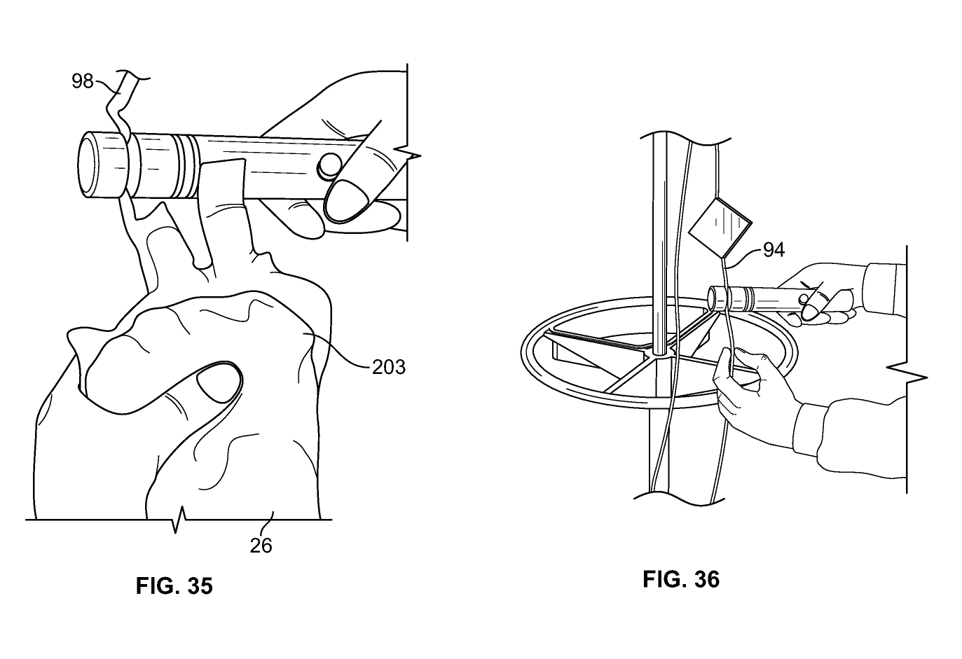

After the fluid 203 has primed the filter 92, the fluid 203 and air within the filter 92 flows through the second tubing line 94 into the lower fluid container 26. To limit the amount of air that flows into the lower fluid container 26, the lower fluid container 26 may include a volume restriction feature (not shown). The volume restriction feature limits the volumetric expansion of the lower fluid container 26 upon receipt of the filtered fluid 203. Limiting the volumetric expansion of the lower fluid container 26 increases the pressure in the lower fluid container 26, thereby increasing the pressure in the lower fluid container 26 and urging the air into the bypass tubing line 98 and into the upper fluid container 22, which may be in a vacuum state. However, if insufficient air is flowing through the bypass tubing line 98 (e.g., venting) into the upper fluid container 22, a person may manipulate the lower fluid container 26 and, thus, urge the air through the bypass tubing line 98. FIGS. 32 and 33 depict a compartment 102 having a volume restriction feature 3202 that may be used to implement any of the examples described herein.

As shown in FIG. 33, the compartment 102 is sized to limit the expansion of at least a portion of the lower fluid container 26. Depending on the application, more or less of the lower fluid container 26 may be positioned in the compartment 102. Thus, the amount that the volume restriction feature 3202 restricts the expansion of the lower fluid container 26 may be tailored to the particular application. While the volume restriction feature 3202 is depicted as having a wedge shape, the volume restriction feature 3202 and/or the compartment 102 may have any other shape and/or size. For example, the compartment 102 may have a cylindrical shape and/or a cubical shape.

As the pressure in the lower fluid container 26 increases, the pressure in the upper fluid container 24 decreases into a vacuum state, for example. When the pressure in the lower fluid container 26 is sufficiently greater than the pressure in the upper fluid container 24, the flow of the fluid 203 through the filter 92 substantially stops. In some examples, when the flow of the fluid 203 substantially, some fluid may remain in the upper fluid container 23. However, the amount of fluid 203 that remains in the upper fluid container 24 may be minimized by suspending the fluid transfer system 22 at the suggested head height, for example.

When the flow of fluid 302 through the filter 92 substantially stops, the first closure device 96 may be reengaged with the second tubing line 94 and the first closure device 96 may initially be left open. The air may then be circulated to the upper fluid container 24. The second closure device 212 may be the reengaged to the bypass tubing line 98 and the second closure device 212 may initially be left open. Generally, as the air accumulation in the upper fluid container 24 increases the pressure in the first tubing line 88 is greater than the pressure in the second tubing line 94. The pressure difference between the tubing lines 88 and 94 urges the remainder of the fluid 203 through the filter 29 and into the lower fluid container 26.

Turning to FIGS. 35 and 36, after filtration is complete and the fluid 203 is now contained in the lower fluid container, the bypass tubing line 98 and the second tubing line 94 may be sealed and severed.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A base of a cart assembly for use with blood filtration, comprising:
a recessed portion to receive one or more containers defining compartments each to receive a container of a fluid transfer system; and
a plurality of transport members coupled to respective portions of the base, wherein a plane on which a surface of the recessed portion lies is below a portion of each of the plurality of transport members.

2. The base as defined in claim 1, wherein a distance between the surface of the recessed portion and an adjacent ground is approximately two inches.

3. The base as defined in claim 1, further comprising a tapered portion between the recessed portion and each of the respective portions of the base.

4. The base as defined in claim 1, wherein each of the compartments comprise a wedge shape.

5. The base as defined in claim 1, wherein the portions of the base comprise corners.

6. The base as defined in claim 1, wherein the container is removably coupled to the base.

7. The base as defined in claim 1, wherein the container is integrally coupled to the base.

8. The base as defined in claim 1, wherein the base comprises at least one of a substantially rectangular shape, a substantially square shape or a substantially circular shape.

9. The base as defined in claim 1, wherein the container comprises a side wall to define a side opening to each of the compartments.

10. The base as defined in claim 1, wherein each of the compartments comprises at least one of a rectangular shape, an ovoid shape or an arcuate shape.

11. A cart assembly for use with blood filtration, comprising:
a base, comprising:
a recessed portion to receive one or more containers defining compartments each to receive a container of a fluid transfer system; and
a plurality of transport members coupled to respective portions of the base, wherein a plane on which a surface of the recessed portion lies is below a portion of each of the plurality of transport members;
a hanger assembly comprising a plurality of suspension members from which another container of the fluid transfer system is to be suspended; and
a pole to couple the base to the hanger assembly.

12. The cart assembly as defined in claim 11, wherein a height of the cart assembly is approximately 77.0 inches.

13. The cart assembly as defined in claim 11, wherein a head height of the cart assembly is approximately 74.0 inches.

14. The cart assembly as defined in claim 11, wherein a distance between the surface of the recessed portion and an adjacent ground is approximately two inches.

15. The cart assembly as defined in claim 11, wherein the pole comprises first and second portions that are telescopically coupled together to enable adjustment of a length of the pole.

16. The cart assembly as defined in claim 11, further comprising a handle coupled to the pole, wherein the handle comprises an annular member that substantially surrounds to pole.

17. The cart assembly as defined in claim 16, wherein the handle comprises crossbeams that define opening to receive a tray.

18. The cart assembly as defined in claim 11, wherein the suspension members extend from a frame of the hanger assembly at a non-perpendicular angle to enable a portion of the other container suspended from the respective suspension member to be at least partially positioned beneath the frame.

19. The cart assembly as defined in claim 11, wherein each of the suspension members is positioned above a corresponding compartment.

20. The cart assembly as defined in claim 11, wherein the transport members comprise rollers.
